(19) United States
(12) Patent Application Publication
(10) Pub. No.: US 2024/0019993 A1
(43) Pub. Date: Jan. 18, 2024

(54) SYSTEMS AND METHODS TO SELECTIVELY CONFIGURE FEATURES OF A USER INTERFACE OF A COMPUTER ENVIRONMENT TO LIMIT DISTRACTIONS

(71) Applicant: ASANA, INC., San Francisco, CA (US)

(72) Inventors: Justin Rosenstein, San Francisco, CA (US); Alexander Hood, San Francisco, CA (US)

(21) Appl. No.: 17/546,760

(22) Filed: Dec. 9, 2021

Related U.S. Application Data
(60) Provisional application No. 63/159,328, filed on Mar. 10, 2021.

(51) Int. Cl. G06F 3/04845; G06F 3/04842

(52) U.S. Cl. CPC G06F 3/04845; G06F 3/04842

(57) ABSTRACT

Systems and methods to selectively configure features of a user interface of a computer environment to limit distractions are disclosed. Exemplary implementations may: manage state information maintaining a computer environment; manage information defining features available within the computer environment while the users access applications; obtain input information conveying user input including user-initiated requests to tailor values of display parameters of the applications; in response to the user input, generate tailored values of the display parameters of the individual applications; implement the computer environment in accordance with the tailored values of the display parameters of the individual applications by presenting the computer environment to reflect the individual subsets of the features; and/or perform other operations.

### FIELD OF THE DISCLOSURE

The present disclosure relates to systems and methods to improve a user interface of a computer environment by selectively configuring features of the user interface to limit distractions.

### BACKGROUND

Computers are able to provide a wide variety of features and/or functionality. These features and functionality may be provided through application programs which are downloaded to a computer or through which functionality is served to the computer through client/server architecture.

### SUMMARY

One aspect of the present disclosure relates to a system configured to selectively configure features of a user interface of a computer environment to limit distractions. Sometimes users need to quickly get into a flow state to efficiently and effectively get work done. However, when it is “crunch time,” users may get distracted by the depth of information, notifications, and/or other features a computer environment provides, making it difficult to focus on a limited set of work. One or more implementations described herein may provide a way to filter out distractions so a user can focus on one (or more) computer applications by improving the way a user interface presents (or limits its presentation of) content. What is automatically filtered out in a user interface, and what is still made available, may be tailored by a given user thereby causing personalized changes to the user interface itself. For example, a user may specifically indicate what features/functionality are not relevant to what they are working on (and therefore filter out/disable as distractions) and what features/functionality are agnostic to distractions (and therefore maintained as available). A user interface of the computer environment may include one or more selectable user interface elements, such as a virtual button or menu option, to quickly engage this mode. Menu(s) may be provided where the user selects what is filtered out and what is still provided. The user selection may include an indication of some level of importance (sliding scale), on/off, a duration associated with the focused mode, and/or other input to indicate whether a feature is a distraction or not. Within this focused mode, one or more features within the computer environment (e.g., notifications, pop-ups, banners, chat interfaces, etc.) may be disabled, silenced, and/or otherwise made unavailable if indicated as distraction. An application-specific user interface for an application being utilized may be shown on a single user interface display, with minimal distractions. Further, the functioning of a server hosting the applications and/or the client computing platforms of the users themselves may be improved by virtue of running in the focused mode. For example, the server may be performing fewer processes (e.g., less processor load) and therefore may run more efficiently due to a reduction of features and/or functionally being served to the client computing platforms (and/or run by the client computing platforms themselves).

One or more implementations of a system to selectively configure features of a user interface of a computer environment to limit distractions may include one or more hardware processors configured by machine-readable instructions. Executing the machine-readable instructions may cause the one or more hardware processors to facilitate selectively configuring features of a user interface of a computer environment to limit distractions. The machine-readable instructions may include one or more computer program components. The one or more computer program components may include one or more of a state component, a focus component, a user interface component, and/or other components.

The state component may be configured to manage state information maintaining a computer environment and/or other information. The computer environment may be configured to facilitate interaction by users with the computer environment. The state information may define one or more application records. The application records may include values of application parameters defining the applications available within the computer environment and/or other information. The application parameters may include display parameters for individual applications. The display parameters may characterize features available within the computer environment while users access individual applications. By way of non-limiting illustration, the application records may include a first application record for a first application.

The state component may be configured to manage information defining the features of the computer environment while the users access individual applications. The computer environment may be configured to exhibit individual sets of the features in accordance with default values of the display parameters for the individual applications during access of the individual applications. By way of non-limiting illustration, the computer environment may exhibit a first set of the features in accordance with the default values of the display parameters of the first application during access of the first application.

The user interface component may be configured to obtain input information conveying user input into the user interface of the computer environment presenting the applications. The user input may include user-initiated requests to tailor the values of the display parameters differently from the default values. Tailoring the values differently from the default values may include changing the values from the default values to other values. By way of non-limiting illustration, the user input may include a first user-initiated request to tailor the values of the display parameters of the first application.

The focus component may be configured to, in response to the user input, generate tailored values of the display parameters of the individual applications. The tailored values of the display parameters for the individual applications may be associated with individual subsets of the features for the computer environment while individual applications are being accessed. By way of non-limiting illustration, in response to the first user-initiated request, the focus component may be configured to generate a first set of tailored values of the display parameters of the first application. The first set of tailored values may be associated with a first subset of the features in the computer environment. The first subset of the features may represent features that may be deemed as non-disruptive so that the user can focus on their interaction with the first application. Accordingly, the features included in the first set of the features but not included in the first subset of the features may include features deemed a distraction.

The user interface component may be configured to implement the computer environment in accordance with the tailored values of the display parameters of the individual applications by presenting the computer environment to reflect the individual subsets of the features during utilization of the individual applications. By way of non-limiting illustration, the computer environment may be implemented in accordance with the first set of tailored values to reflect the first subset of the features while the first application is being accessed following the first user-initiated request.

As used herein, any association (or relation, or reflection, or indication, or correspondency) involving servers, processors, client computing platforms, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1).

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to selectively configure features of a computer environment to limit distractions, in accordance with one or more implementations.

FIG. 2 illustrates a method to selectively configure features of a computer environment to limit distractions, in accordance with one or more implementations.

FIG. 3 illustrates a user interface, in accordance with one or more implementations.

FIG. 4 illustrates a user interface, in accordance with one or more implementations.

### DETAILED DESCRIPTION

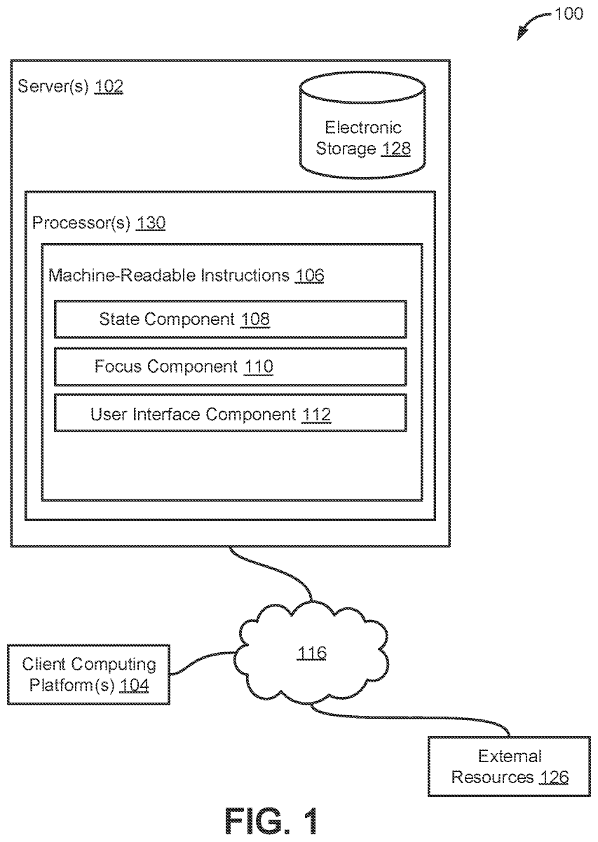

FIG. 1 illustrates a system 100 configured to selectively configure features of a computer environment to limit distractions, in accordance with one or more implementations. The system 100 may limit one or more features and/or functionality of a user interface presenting the computer environment to help reduce distractions. A user interface of the computer environment may include a selectable user interface element such as a virtual button or menu option to quickly engage this mode. Within this focused mode, one or more features in the computer environment may be disabled, silenced, and/or otherwise not made available. Disabling features may reduce the processing requirements at server(s) hosting one or more applications. A computer application being utilized may be shown on a single display, with minimal distractions.

In some implementations, system 100 may include one or more of one or more servers 102, one or more client computing platforms 104, external resources 126, and/or other components. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104. In some implementations, individual client computing platforms may include the same and/or similar functionality as server(s) 102. By way of non-limiting illustration, a client computing platform may include processor executing machine-readable instructions that may be the same and/or similar to machine-readable instructions 106.

Server(s) 102 may include one or more of non-transitory electronic storage 128, one or more processors 130 configured by machine-readable instructions 106, and/or other components. Machine-readable instructions 106 may include one or more instruction components. The instruction components may include computer program components. Executing the machine-readable instructions 106 may cause server(s) 102 to facilitate selectively configuring features of a computer environment to limit distractions. The computer program components may include one or more of a state component 108, a focus component 110, a user interface component 112, and/or other instruction components.

State component 108 may be configured to manage state information and/or other information used in maintaining a computer environment. The computer environment may be configured to facilitate interaction by users with applications (sometimes referred to as “computer applications”). In some implementations, the computer environment may comprise an environment configured to be presented on a mobile computing platform. Such an environment may be referred to as a “mobile computing environment.” In some implementations, the computer environment may comprise an environment configured to be presented on a stationary computing platform. Such an environment may be referred to as a “desktop computing environment.”

A computer application may refer to a software program and/or group of programs configured to perform some action and/or provide some functionality in the computer environment. In some implementations, the functionality may be provided to client computing platform(s) 104 from server(s) 102 via client/server architecture. In some implementations, the functionality may be facilitated locally within client computing platform(s) 104 based on executing computer-program instructions locally at client computing platform(s) 104.

A computer application may comprise a mobile application and/or a desktop application. In some implementations, a computer application may include an application requiring user intervention to perform an action and/or provide functionality. In some implementations, a computer application may be autonomous such that little or no user intervention may be required for the application to run. By way of non-limiting illustration, a computer application may include one or more of a word processing application, an electronic communication application (e.g., email, instant messaging, calling, VOIP, video chat, etc.), information access application (e.g., web browser), social media application, a collaborative work management platform, a calendar application, a payment application, restaurant-reservation application, on-demand delivery application, a project management application, a customer relationship management application, a ticketing application, a partner relationship management application, a web form application, and/or other applications. It is noted that this list of applications is for illustrative purposes only and not to be considered limiting. Instead, it is to be understood that other applications may be considered and are within the scope of the present disclosure.

A calendar application may comprise a software application configured to provide users with an electronic version of a calendar. The calendar application may provide an appointment book, address book, contact list, and/or other features and/or functionality. In some implementations, a calendar application may provide functionality of setting calendar events, setting reminders, and/or other functionality.

A payment application may comprise an e-commerce payment application, electronic payment application, peer-to-peer payments application, an electronic wallet application, and/or other applications that facilitate the sending and/or receiving of electronic payments and/or other online transactions.

An electronic communication application may comprise an application for providing electronic communication services. Electronic communication services may include one or more of electronic mail, instant messaging, private messaging, and/or other communications. An electronic communication application may provide functionality of one or more of compiling, sending, receiving, archiving, deleting, and/or performing other actions with respect to electronic communications.

A social media application may comprise an application configured to facilitate the creation and/or sharing of information via virtual communities and/or networks. A social media application may provide functionality of compiling, posting, reviewing, deleting, searching, and/or performing other actions with respect to information created and/or shared via virtual communities and/or networks.

A restaurant-reservation application may include an application configured to set and/or request reservations and restaurants in response to web-based requests for reservations. The restaurant-reservation application may be specific to a given restaurant and/or an application that services many restaurants. A restaurant-reservation application may provide the functionality of searching restaurants, searching availability of reservations, communicating with restaurants, setting reservations, sending confirmations, and/or other features and/or functionality.

An on-demand delivery application may comprise an application configured to effectuate real-world deliveries of real-world goods and/or services in response to web-based requests for those goods and/or services. The on-demand delivery application may be associated with what may commonly be referred to as a “gig economy” application. By way of non-limiting illustration, an on-demand delivery application may be directed to food delivery, consumer items, and/or other goods and/or services.

A project management application may comprise an application configured to facilitate planning, organizing, and/or otherwise managing resources. A project management application may provide functionality of estimation and planning, scheduling, cost control and budget management, resource allocation, communication, decision-making, quality management, time management and documentation, administration systems, and/or other functionality.

The state information may include one or more of user records including user information, application records including application information and/or other information used to define, support, and/or otherwise maintain a computer environment.

The user information in the user records may include values of user parameters. The values of the user parameters may be organized in user records corresponding to users interacting with and/or viewing the computer environment. The values of the user parameters may include information describing the users, their actions within the computer environment, their settings, and/or other user information; and/or metadata associated with the users, their actions within the environment, their settings, and/or other user information. Individual ones of the users may be associated with individual ones of the user records. A user record may define values of the user parameters associated with a given user.

The values of the user parameters may, by way of non-limiting example, specify one or more of: a user name, a user account, a user department, descriptive user content, a to-email, a from-email, a photo, an organization, a workspace, one or more teams the user belongs to, one or more of the user display settings (e.g., colors, size, project order, task order, other unit of work order, etc.), one or more authorized applications, one or more interaction parameters (e.g., indicating a user is working on/worked on a given application, a given user viewed a given application, a given user selected a given application, a timeframe a given user last interacted with and/or worked on a given application, a time period that a given application has been idle, and/or other interaction parameters), one or more notification settings, one or more progress parameters, status information for one or more applications the user is associated with, one or more performance metrics of a given user (e.g., how many applications the user has utilized, how often the user utilizes applications, and/or other information), application access information (e.g., username/password for individual applications), one or more favorites and/or priorities, and/or other information.

The application information in the application records may include values of application parameters. The values of the application parameters may be organized in application records corresponding to application available within the computer environment. The values of the application parameters may include information describing individual applications, features and/or functionality the individual applications facilitate within the computer environment, current and/or manufacturer settings of the individual applications, and/or other application information. Individual ones of the applications may be associated with individual ones of the application records. An application record may define values of the application parameters associated with a given application and/or other information.

In some implementations, application parameters may include display parameters and/or other parameters. The values of the display parameters may characterize features of the computer environment and/or a user interface through which the users access the applications available within the computer environment. An application may be presented in a portion of the user interface and/or in a user interface dedicated to the application. By way of non-limiting illustration, the application records may include a first application record for a first application.

In some implementations, the computer environment may exhibit and/or include features in accordance with values of the display parameters for individual applications. The features may include one or more of display features, functionality features, and/or other features.

The display features may correspond to visual content displayed in the computer environment. Visual content displayed in the computer environment may refer to content which is presented visually and may or may not facilitate direct user interaction with the applications. The display features may include one or more of a notification display feature, an aesthetic display feature, a GUI arrangement feature, and/or other features.

A value of a display parameter characterizing a notification display feature may correspond to visual content conveying notifications and/or alerts. Notifications and/or alerts may include one or more of system notifications and/or alerts, notifications and/or alerts from other users, notifications and/or alerts from individual applications, notifications and/or alerts from external resource(s) 126, and/or other information. The value of the display parameter characterizing the notification display feature may include one or more of an indication of availability, an extent or degree in which the visual content is displayed, and/or other information. An indication of availability may include whether the feature as a whole is enabled (e.g., presented in the user interface) or disabled (e.g., not presented in the user interface and/or not served to client computing platforms from server(s) 102). The extent or degree in which the visual content is displayed may include an indication of types of information that are (and/or are not) included in the visual content. By way of non-limiting illustration, a value of the display parameter characterizing the notification display feature may indicate that notifications and/or alerts from one or more applications are enabled but notifications and/or alerts from other users (e.g., instant messages) are disabled.

A value of a display parameter characterizing an aesthetic display feature may correspond to visual content including aesthetic features. Aesthetic features may refer to features that generally do not provide functional benefit and/or convey usable information to a user, but may be included in a user interface for their pleasing characteristics. By way of non-limiting illustration, aesthetic features may include one or more of color and/or design of backgrounds, color and/or design of individual GUI elements, graphic display banners, and/or other features. The value of the display parameter characterizing the aesthetic display feature may include one or more of an indication of availability, an extent or degree in which the visual content is displayed, and/or other information. An indication of availability may include whether the feature as a whole is enabled (e.g., presented in the computer environment) or disabled (e.g., not presented in the computer environment). The extent or degree in which the visual content is displayed may include an indication of types of aesthetic features that are (and/or are not) included in the visual content. By way of non-limiting illustration, a value of the display parameter characterizing the aesthetic display feature may indicate that displaying a color background in computer environment and/or an application-specific user interface is enabled but displaying a graphic banner is disabled.

A value of a display parameter characterizing a GUI arrangement feature may correspond to visual content comprising the arrangement of various GUI elements of a user interface of the computer environment as a whole and/or an application-specific user interface of an individual application. The arrangement of various GUI elements may refer to particular GUI elements that are presented and/or how they are presented. By way of non-limiting illustration, individual GUI elements may be used to convey features and/or functionality of individual applications and/or the computer environment, generally. How they are presented may refer to location and/or size of the elements. Location may include centered, at an edge, at a corner, and/or other locations. Size may include larger (than a default size and/or relative to other elements), smaller (than a default size and/or relative to other elements), and/or other considerations. The value of the display parameter characterizing the GUI arrangement feature may include one or more of an indication of availability, an extent or degree in which the visual content is displayed, and/or other information. An indication of availability may include whether the feature as a whole is enabled (e.g., presented in a user interface) or disabled (e.g., not presented in a user interface). The extent or degree in which the visual content is displayed may include an indication of types of elements that are (and/or are not) included in an arrangement and/or how they are presented. By way of non-limiting illustration, a value of the display parameter characterizing the GUI arrangement feature may indicate that GUI elements (e.g., icons) representing individual applications a user is utilizing are displayed larger and centered in a user interface of the computer environment, while other GUI elements (e.g., such as other icons representing other applications a user is not utilizing) are removed and/or made relatively smaller in the user interface. By way of non-limiting illustration, a value of the display parameter characterizing the GUI arrangement feature may indicate that GUI elements representing a particular subset of features of an application are the only GUI elements displayed in a particular view of a user interface.

The functionality features may correspond to functional content available in the computer environment. Functional content available in the computer environment may refer to one or more of content that may facilitate direct user interaction with applications and/or the computer environment as a whole, content that may return information and/or perform an action in response to the user interaction, and/or other content. The functionality features may include one or more of a navigation feature, a communication feature, a resource access feature, and/or other features.

A value of a display parameter characterizing a navigation feature may correspond to functionality of navigating through the computer environment. Navigating through the computer environment may include navigating between applications, windows, and/or other views provided by the computer environment. Navigation may be facilitated by scrolling, selecting, switches, and/or other techniques. The value of the display parameter characterizing the navigation feature may include one or more of an indication of availability, an extent or degree in which the functionality associated therewith is enabled (or disabled), and/or other information. An indication of availability may include whether the functionality as a whole is enabled (e.g., navigation is available) or disabled (e.g., navigation is not available). The extent or degree in which the functionality is enabled may include an indication of limits and/or constraints on the functionality. By way of non-limiting illustration, a value of the display parameter characterizing the navigation feature may indicate that navigation away from an application as whole is disabled. By way of non-limiting illustration, a value of the display parameter characterizing the navigation feature may indicate that navigation from an application to one or more specified applications of the computer environment are enabled but navigation to one or more other specified applications is disabled.

A value of a display parameter characterizing a communication feature may correspond to the functionality of communicating via the computer environment. Communicating via the computer environment may be facilitated by one or more of synchronous communication, asynchronous communication, semi-synchronous communication, and/or other techniques. Communicating via the computer environment may include one or more of instant messaging, posting of comments, accessing social media, posting on a message thread and/or board, emailing, and/or other communication techniques. The value of the display parameter characterizing the communication feature may include one or more of an indication of availability, an extent or degree in which the functionality associated therewith is enabled (or disabled), and/or other information. An indication of availability may include whether the functionality as a whole is enabled (e.g., communication is available) or disabled (e.g., communication is not available). The extent or degree in which the functionality is enabled may include an indication of limits and/or constraints on the functionality. By way of non-limiting illustration, a value of the display parameter characterizing a communication feature may indicate that communication as whole is disabled. By way of non-limiting illustration, a value of the display parameter characterizing a communication feature may indicate that communication with a limited set of one or more users is enabled. By way of non-limiting illustration, a value of the display parameter characterizing a communication feature may indicate that communication via a particular application (e.g., email) is enabled but communication via another application (e.g., social media) is disabled.

A value of a display parameter characterizing a resource access feature may correspond to the functionality of accessing resources outside of the computer environment (e.g., external resource(s) 126) and/or resources internal to the computer environment (e.g., one or more applications and/or other internal resources). Accessing resources outside of the computer environment may be facilitated by one or more of third-party applications existing outside of the computer environment, third-party applications existing outside of the computer environment but accessible through the computer environment without leaving the computer environment, and/or other techniques. The value of the display parameter characterizing the resource access feature may include one or more of an indication of availability, an extent or degree in which the functionality associated therewith is enabled (or disabled), and/or other information. An indication of availability may include whether the functionality as a whole is enabled (e.g., access to an external resource and/or other application is available) or disabled (e.g., access to external resource and/or other application is not available). The extent or degree in which the functionality is enabled may include an indication of limits and/or constraints on the functionality. By way of non-limiting illustration, a value of the display parameter characterizing the resource access feature may indicate that access to external resources as a whole is disabled. By way of non-limiting illustration, a value of the display parameter characterizing the resource access feature may indicate that access to a given internal resource is enabled while access to one or more applications is disabled. By way of non-limiting illustration, the given internal resource may include a tool bar for adjusting display resolution, while the one or more applications may include social media applications.

State component 108 may be configured to manage information defining features available within the computer environment while the users access the applications. Managing information features available within the computer environment while the users access the applications may include determining, obtaining, and/or modifying values of display parameters of the individual applications. Managing information defining features available within the computer environment while the users access the applications may include providing values of display parameters and/or other information to the user interface component 112 to effectuate presentation of the computer environment in accordance with the values.

The computer environment being configured to exhibit individual sets of the features in accordance with default values of the display parameters for the individual applications during access of the individual applications. By way of non-limiting illustration, the computer environment may exhibit a first set of the features in accordance with default values of the display parameters of the first application during access of the first application.

The user interface component 112 may be configured to effectuate presentation of individual user interfaces on individual client computing platforms of one or more client computing platforms 104. The user interface component 112 may be configured to effectuate presentation of a user interface of the computer environment and/or one or more applications based on state information and/or other information. The user interface may display one or more application-specific interfaces of the individual applications and/or other information.

In some implementations, state information may be updated as users continue to interact with the computer environment via the user interfaces of the applications over time. The state component 108 may store and/or archive the state information periodically and/or based on user request to archive.

In some implementations, user interface component 112 may be configured to obtain input information and/or other information. The input information may convey user input into a user interface presented on the client computing platform(s) 104. A set of user interface elements may be provided on the user interface to facilitate the user input and/or other user interaction with the user interface. The user interface elements may include one or more of text input fields, drop-down menus, check boxes, display windows, virtual buttons, and/or other elements configured to facilitate user interaction.

The input information may convey user input into a user interface of the computer environment presenting one or more applications. The user input may include one or more of user-initiated requests to tailor the values of the display parameters for individual applications differently from the default values, duration over which tailored values of the display parameters of the individual applications are implemented, context information, and/or other information. By way of non-limiting illustration, the user input may include a first user-initiated request to tailor the values of the display parameters of the first application.

In some implementations, tailoring the values of the display parameters differently from the default values may cause the set of features available in the computer environment to be reduced and/or modified to reflect a subset of the features. Accordingly, tailoring the values of the display parameters may reflect the individual subsets of the features by disabling and/or modifying one or more of the features not included in the individual subsets of the features. In some implementations, tailoring the values of the display parameters may be achieved by limiting the information being served to the client computing platform(s) 104 from resource(s) within and/or external to the system 100. In some implementations, the user input may include specific indication of one or more of the display features and/or one or more of the functionality features to enable and/or disable.

In some implementations, the user input may include duration over which tailored values of the display parameters of the individual applications are implemented. Upon reaching the duration, the values of the display parameters may be set back to the default values. In some implementations, the values of the display parameters may be set back to the default values when a user specifically exits an application and/or provides input into a user interface element to set the values back to the default values.

In some implementations, the user input may include input defining context information for a given application. The context information may describe relationships between an application and the features available in the computer environment. In some implementations, a relationship between a given application and a given feature may be defined by a relevancy measure and/or other information. In some implementations, the relevancy measure between a given feature and a given application may convey one or more of an indication of whether the given feature assists in a utilization of (or distracts from the utilization of) the given application, an extent or degree in which the given feature assists in a utilization of (or distracts from the utilization of) the given application, and/or other information. An indication of whether the given feature assists in a utilization of (or distracts from the utilization of) the given application may be binary, meaning the relevancy measure may convey the given feature either “assists” or “detracts” and the feature is either “enabled” or “disabled”. “Assists” may mean that the feature is relevant; “detracts” may mean that the feature is a distraction. The extent or degree in which the given feature assists in a utilization of (or distracts from the utilization of) the given application may comprise a sliding scale of values. For example, extent or degree in which the given feature assists in a utilization of (or distracts from the utilization of) the given application may comprise one or more of greatly assists, assists, moderately assists, neutral, moderately detracts, detracts, greatly detracts, and/or other information.

In some implementations, user interface component 112 may be configured to effectuate presentation of a user interface and/or a user interface portion configured to receive user input conveying context information. The user interface and/or user interface portion may include one or more of a menu, drop-down menu, check boxes, and/or other features. By way of non-limiting illustration, a pop-up menu may be displayed within an application-specific user interface (e.g., a window) for an application. The pop-up menu may display a set of features available in the computer environment for one or more applications. For individual features, the user may provide input of a relevancy measure as it relates to a given application. In some implementations, a menu may be provided where a user provides input of a relevancy measure for individual features as it applies to more than one application. By way of non-limiting illustration, a user may input that an instant messaging feature within a social media application has little to no relevance to a word processing application such that it is deemed a distraction. However, the user may input that an email messaging application has little to some relevance to a word processing application since the user may expected an email message to assist in a work processing task.

The focus component 110 may be configured to generate tailored values of the display parameters of the individual applications in response to the user input obtained by user interface component 112. The tailored values of the display parameters for the individual applications may be associated with individual subsets of the features for the computer environment. By way of non-limiting illustration, in response to the first user-initiated request, focus component 110 may be configured to generate a first set of tailored values of the display parameters of the first application. The first set of tailored values may be associated with a first subset of the features in the computer environment.

In some implementations, generating the tailored values of the display parameters of the individual applications may be based on the context information and/or other information. In some implementations, the features associated with a relevancy measure conveying that a given feature assists in the utilization of the given application may be features included in the individual subsets of features. In some implementations, the features associated with a relevancy measure meeting and/or exceeding a threshold on the sliding scale may be features included in the individual subsets of features. By way of non-limiting illustration, the tailored values of the display parameters for the given application may be generated based on the context information for the given application so that a given subset of the features for the computer environment for the given application reflects the relevancy between the given application and individual features in the given subsets of the features.

The user interface component 112 may be configured to implement the computer environment in accordance with the tailored values of the display parameters of the individual applications by presenting the computer environment exhibiting the individual subsets of the features. The computer environment may be implemented in accordance with the tailored values for a given application while the given application is being accessed and/or following a user-initiated request. By way of non-limiting illustration, the computer environment may be implemented in accordance with the first set of tailored values to reflect the first subset of the features while the first application is being accessed and/or following the first user-initiated request. In some implementations, implementing the computer environment in accordance with the tailored values may include effectuating presentation of the computer environment.

In some implementations, effectuating presentation of the computer environment in accordance with the tailored values of the display parameters to reflect the individual subsets of the features may include disabling and/or modifying one or more of the features not included in the individual subsets of the features. The features not included in the individual subsets of the features may be features which may be deemed as being distracting and/or not pertinent to the application(s) at hand.

In some implementations, the features in the computer environment may include one or more agnostic features that are agnostic to the user-initiated requests to limit distractions. Accordingly, the one or more agnostic features may be made available in the computer environment when either the default values or the tailored values are set for the display parameters of the individual applications while the applications are being utilized. By way of non-limiting illustration, the one or more agnostic features may be present in the first set of the features and the first subset of the features as it relates to the utilization of the first application.

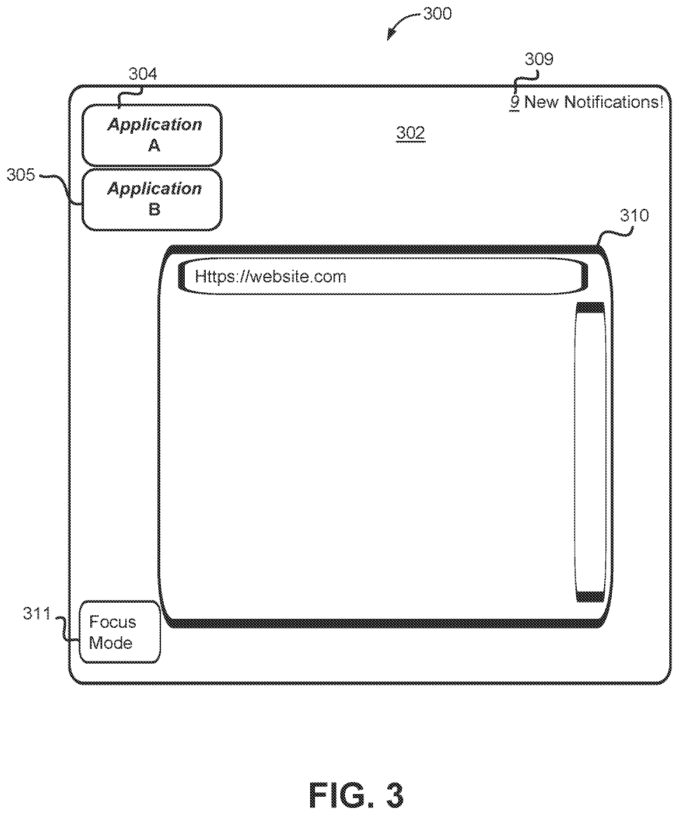

FIG. 3 illustrates a user interface 300, in accordance with one or more implementations. The user interface 300 may display a computer environment 302. The computer environment 302 may include an application-specific user interface 310 specific to a first application. The user interface 300 may facilitate a variety of display features and functionality features. The user interface 300 include display features and functionality features configured based on values of the display parameters of the first application and/or other applications. For illustrative purposes, FIG. 3 may represent default values of the display parameters (e.g., prior to improving the user interface 300 by filtering out distractions). The user interface 300 may include various user interface elements corresponding to features available to a user accessing the first application via the application-specific user interface 310. By way of non-limiting illustration, a user interface element 304 may display an icon—the selection of which may facilitate access to another application (e.g., Application A). A user interface element 305 may display an icon—the selection of which may facilitate access to yet another application (e.g., Application B). A user interface element 309 may display notification and/or alerts and/or provide functionality of accessing the notifications and/or alerts from the computer system and/or one or more applications. A user interface element 311 may provide functionality of tailoring the values of the display parameters different from the default values.

As mentioned, FIG. 3 may represent default values of the display parameters and prior to improving the user interface 300 by filtering out distractions. As such, the user interface 300 may include an overwhelming amount of information. Given the task at hand, e.g., interacting with application-specific user interface 310, a user may have difficulty staying focused to complete the task efficiently. This difficulty may be compounded because of the quantity of items on the user interface 300. Accordingly, a user may select user interface element 311 to tailor the values of the display parameters to limit distractions.

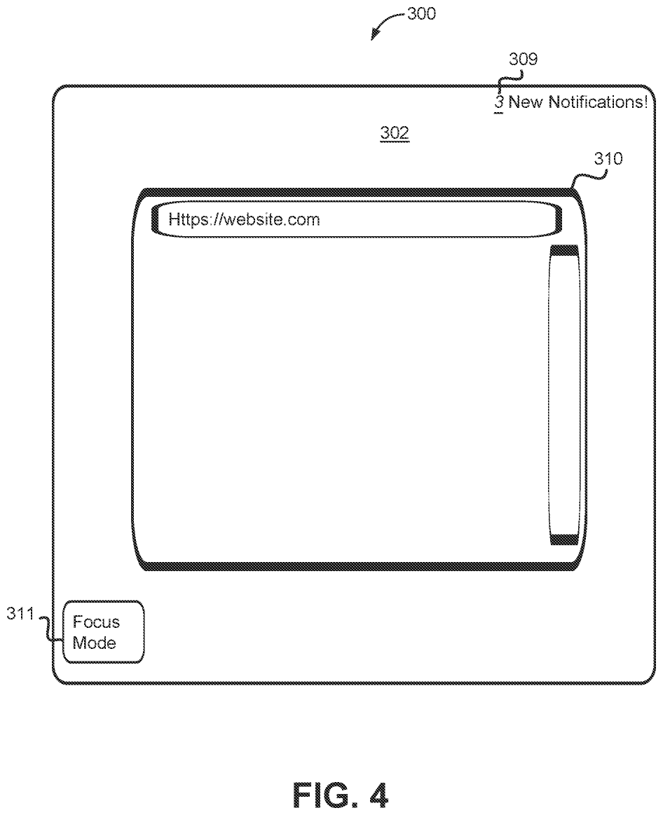

FIG. 4 illustrates the user interface 300 of FIG. 3 in accordance with tailored values of the display parameters to reflect a reduction and/or modification of the features available via user interface 300. For example, user interface elements 304 and/or 305 which facilitate access to other applications may be deemed a distraction and removed from the user interface 300. The application-specific user interface 310 may be resized and/or centered in the user interface 300. Accordingly, application-specific user interface 310 may be more prominent in the user interface 300. The user interface element 309 may show a reduced quantity of notifications and/or alerts as some of the notifications and/or alerts may have been disabled due to the tailoring of the values of the display parameters.

It is noted that FIGS. 3-4 are for illustrative purposes only and are not to be considered limiting. Instead, it is to be understood that user interfaces may be configured in other ways and/or including other elements in accordance with one or more implementations of the system 100 presented herein. Further, it is noted that while the features and/or functions of the systems and methods presented herein are directed to application-specific user interfaces presenting application, this is for illustrative purposes only and is not to be considered strictly limiting. Instead, those skilled in the art may appreciate that the functionality of tailoring values of display parameters to impact features available within a user interface may be applied to other types and/or configurations of user interfaces and/or pages displayed within a user interface.

Referring back to FIG. 1, in some implementations, server(s) 102, client computing platform(s) 104, and/or external resources 126 may be operatively linked via one or more electronic communication links. For example, such electronic communication links may be established, at least in part, via a network 116 such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform may include one or more processors configured to execute computer program components. The computer program components may be configured to enable an expert or user associated with the given client computing platform to interface with system 100 and/or external resources 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a smartphone, a gaming console, and/or other computing platforms.

External resources 126 may include sources of information outside of system 100, external entities participating with system 100, and/or other resources. In some implementations, some or all of the functionality attributed herein to external resources 126 may be provided by resources included in system 100.

Server(s) 102 may include electronic storage 128, one or more processors 130, and/or other components. Server(s) 102 may include communication lines, or ports to enable the exchange of information with a network 116 and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, and/or other components. Processor(s) 130 may be configured to execute components 108, 110, and/or 112, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, and/or 112 are illustrated in FIG. 1 as being implemented within a single processing unit, in implementations in which processor(s) 130 includes multiple processing units, one or more of components 108, 110, and/or 112 may be implemented remotely from the other components. The description of the functionality provided by the different components 108, 110, and/or 112 described below is for illustrative purposes, and is not intended to be limiting, as any of components 108, 110, and/or 112 may provide more or less functionality than is described. For example, one or more of components 108, 110, and/or 112 may be eliminated, and some or all of its functionality may be provided by other ones of components 108, 110, and/or 112. As another example, processor(s) 130 may be configured to execute one or more additional components that may perform some or all of the functionality attributed below to one of components 108, 110, and/or 112.

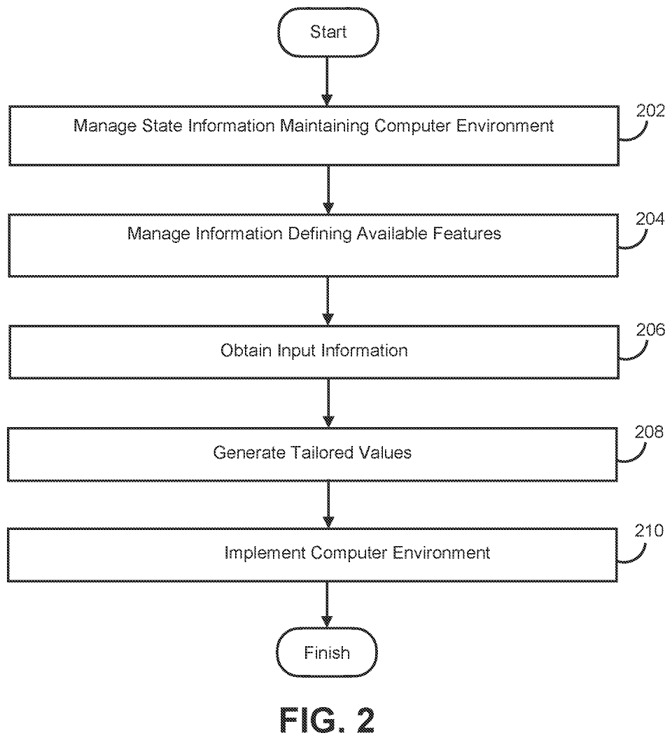

FIG. 2 illustrates a method 200 to selectively configure features of a user interface of a computer environment to limit distractions, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may manage state information maintaining a computer environment and/or other information. The computer environment may be configured to facilitate interaction by users with the computer environment. The state information may include application records and/or other records. The application records may include values of application parameters defining the applications available within the computer environment. Application parameters including display parameters for individual applications and/or other parameters. The display parameters may characterize features available within the computer environment while users access the applications. By way of non-limiting illustration, the application records may include a first application record for a first application. Operation 202 may be performed by one or more hardware processors configured by machine-readable instructions including a component that is the same as or similar to state component 108, in accordance with one or more implementations.

An operation 204 may manage information defining the features available within the computer environment while the users access the applications. The computer environment may be configured to exhibit individual sets of the features in accordance with default values of the display parameters for the individual applications during access of the individual applications. By way of non-limiting illustration, the computer environment may exhibit a first set of the features in accordance with the default values of the display parameters of the first application during access of the first application. Operation 204 may be performed by one or more hardware processors configured by machine-readable instructions including a component that is the same as or similar to state component 108, in accordance with one or more implementations.

An operation 206 may obtain input information conveying user input into a user interface of the computer environment presenting the applications. The user input may include user-initiated requests to tailor the values of the display parameters differently from the default values. By way of non-limiting illustration, the user input may include a first user-initiated request to tailor the values of the display parameters of the first application. Operation 206 may be performed by one or more hardware processors configured by machine-readable instructions including a component that is the same as or similar to user interface component 112, in accordance with one or more implementations.

An operation 208 may, in response to the user input, generate tailored values of the display parameters of the individual applications. The tailored values of the display parameters for the individual applications may be associated with individual subsets of the features for the computer environment. By way of non-limiting illustration, in response to the first user-initiated request, a first set of tailored values of the display parameters of the first application may be generated. The first set of tailored values may be associated with a first subset of the features in the computer environment. Operation 208 may be performed by one or more hardware processors configured by machine-readable instructions including a component that is the same as or similar to focus component 110, in accordance with one or more implementations.

An operation 210 may implement the computer environment in accordance with the tailored values of the display parameters of the individual applications by presenting the computer environment to reflect the individual subsets of the features. By way of non-limiting illustration, the computer environment may be implemented in accordance with the first set of tailored values to reflect the first subset of the features while the first application is being accessed and/or following the first user-initiated request. Operation 210 may be performed by one or more hardware processors configured by machine-readable instructions including a component that is the same as or similar to user interface component 112, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured to selectively configure features of a computer environment to limit distractions during user engagement with an individual application of the computer environment, the system comprising:
one or more physical processors configured by machine-readable instructions to:
manage state information maintaining a computer environment, the computer environment being configured to facilitate interaction by a user with applications available within the computer environment, the state information including application records, the application records including values of application parameters defining the applications available within the computer environment, the application parameters characterizing display features and functionality features available within the computer environment while the user accesses individual ones of the applications, such that the application records include a first application record for a first application and a second application record for a second application;
manage information defining features available within the computer environment while the user accesses the individual ones of the applications, the computer environment being configured to exhibit individual sets of the display features and functionality features in accordance with default values of the application parameters, such that the computer environment exhibits a first set of the display features and a second set of the functionality features in accordance with the default values of the application parameters during access of the first application;
obtain input information conveying user input into individual user interfaces of the individual ones of the applications, the user input including user-initiated requests to tailor the values of the application parameters differently from the default values while the user accesses the individual ones of the applications, such that the user input into a first user interface of the first application includes a first user-initiated request to tailor the values of the application parameters characterizing the display features and the functionality features available within the computer environment while the user accesses the first application;
in response to the user input, generate tailored values of the application parameters characterizing the display features and the functionality features available within the computer environment while the user accesses the individual ones of the applications, wherein the tailored values of the application parameters are associated with individual subsets of the display features and the functionality features available within the computer environment, including in response to the first user-initiated request, generate a first set of tailored values of the application parameters characterizing the display features available within the computer environment and a second set of tailored values of the application parameters characterizing the functionality features available within the computer environment while the user accesses the first application, the first set of tailored values being associated with a first subset of the display features available within the computer environment, the second set of tailored values being associated with a second subset of the functionality features available within the computer environment, wherein the first subset of the display features and the second subset of the functionality features available within the computer environment while the user accesses the first application limit operation of, or access to, the second application; and
implement the computer environment in accordance with the tailored values of the application parameters by presenting the computer environment to reflect the individual subsets of the display features and the functionality features while the user accesses the individual ones of the applications, such that the computer environment is implemented in accordance with the first set of tailored values and the second set of tailored values to reflect the first subset of the display features and the second subset of the functionality features available within the computer environment while the first application is being accessed following the first user-initiated request.

2. The system of claim 1, wherein implementing the computer environment in accordance with the tailored values of the application parameters includes disabling and/or modifying one or more of the display features and one or more of the functional features not included in the individual subsets.

3. The system of claim 1, wherein the display features correspond to visual content displayed in the computer environment, and the functionality features correspond to functional content available in the computer environment.

4. The system of claim 3, wherein the functionality features include one or more of a navigation feature, a communication function, or an external resource access feature and wherein limiting operation of the second application includes temporarily disabling notifications from the second application.

5. The system of claim 3, wherein the display features include one or more of a notification display feature, an aesthetic display feature, or a GUI arrangement feature and wherein limiting access to the second application includes temporarily removing a GUI element associated with the second application from a desktop.

6. The system of claim 3, wherein the user input includes specific indication of one or more of the display features and/or one or more of the functionality features to enable and/or disable.

7. The system of claim 1, wherein one or more of the features include one or more agnostic features that are agnostic to the user-initiated requests, such that the one or more agnostic features are made available in the computer environment when either the default values or the tailored values are set for the application parameters.

8. The system of claim 1, wherein the user input further includes duration over which the tailored values of the application parameters are implemented, such that upon reaching the duration, the tailored values of the application parameters are set back to the default values.

9. The system of claim 1, wherein generating the tailored values of the application parameters is based on context information, the context information describing relationships between the applications and the features, wherein a relationship between a given application and a given feature is defined by a relevancy, such that the tailored values of the application parameters for the given application are generated based on the context information for the given application so that a given subset of the features for the computer environment reflects the relevancy between the given application and individual features in the given subset of the features.

10. The system of claim 9, wherein the relevancy is dictated by a measure of whether the given feature assists in a utilization of the given application or distracts from the utilization.

11. A method to selectively configure features of a computer environment to limit distractions during user engagement with an individual application of the computer environment, the method comprising:
managing state information maintaining a computer environment, the computer environment being configured to facilitate interaction by a user with applications available within the computer environment, the state information including application records, the application records including values of application parameters defining the applications available within the computer environment, the application parameters characterizing display features and functionality features available within the computer environment while the user accesses individual ones of the applications, such that the application records include a first application record for a first application and a second application record for a second application;
managing information defining features available within the computer environment while the user accesses the individual ones of the applications, the computer environment being configured to exhibit individual sets of the display features and functionality features in accordance with default values of the application parameters, such that the computer environment exhibits a first set of the display features and a second set of the functionality features in accordance with the default values of the application parameters during access of the first application;
obtaining input information conveying user input into individual user interfaces of the individual ones of the applications, the user input including user-initiated requests to tailor the values of the application parameters differently from the default values while the user accesses the individual ones of the applications, such that the user input into a first user interface of the first application includes a first user-initiated request to tailor the values of the application parameters characterizing the display features and functionality features available within the computer environment while the user accesses the first application;
in response to the user input, generating tailored values of the application parameters characterizing the display features and functionality features available within the computer environment while the user accesses the individual ones of the applications, wherein the tailored values of the application parameters are associated with individual subsets of the display features and functionality features available within the computer environment, including in response to the first user-initiated request, generating a first set of tailored values of the application parameters characterizing the display features available within the computer environment and a second set of tailored values of the application parameters characterizing the functionality features available within the computer environment while the user accesses the first application, the first set of tailored values being associated with a first subset of the display features available within the computer environment, the second set of tailored values being associated with a second subset of the functionality features available within the computer environment, wherein the first subset of the display features and the second subset of the functionality features available within the computer environment while the user accesses the first application limit operation of, or access to, the second application; and
implementing the computer environment in accordance with the tailored values of the application parameters by presenting the computer environment to reflect the individual subsets of the display features and functionality features while the user accesses the individual ones of the applications, including implementing the computer environment in accordance with the first set of tailored values and the second set of tailored values to reflect the first subset of the display features and the second subset of the functionality features available within the computer environment while the first application is being accessed following the first user-initiated request.

12. The method of claim 11, wherein the implementing the computer environment in accordance with the tailored values of the application parameters includes disabling and/or modifying one or more of the display features and one or more of the functional features not included in the individual subsets.

13. The method of claim 11, wherein the display features correspond to visual content displayed in the computer environment, and the functionality features correspond to functional content available in the computer environment.

14. The method of claim 13, wherein the functionality features include one or more of a navigation feature, a communication function, or an external resource access feature and wherein limiting operation of the second application includes temporarily disabling notifications from the second application.

15. The method of claim 13, wherein the display features include one or more of a notification display feature, an aesthetic display feature, or a GUI arrangement feature and wherein limiting access to the second application includes temporarily removing a GUI element associated with the second application from a desktop.

16. The method of claim 13, wherein the user input includes specific indication of one or more of the display features and/or one or more of the functionality features to enable and/or disable.

17. The method of claim 11, wherein one or more of the features include one or more agnostic features that are agnostic to the user-initiated requests, such that the one or more agnostic features are made available in the computer environment when either the default values or the tailored values are set for the application parameters.

18. The method of claim 11, wherein the user input further includes duration over which the tailored values of the application parameters are implemented, such that upon reaching the duration, the tailored values of the application parameters are set back to the default values.

19. The method of claim 11, wherein the generating the tailored values of the application parameters is based on context information, the context information describing relationships between the applications and the features, wherein a relationship between a given application and a given feature is defined by a relevancy, such that the tailored values of the application parameters for the given application are generated based on the context information for the given application so that a given subset of the features for the computer environment reflects the relevancy between the given application and individual features in the given subset of the features.

20. The method of claim 19, wherein the relevancy is dictated by a measure of whether the given feature assists in a utilization of the given application or distracts from the utilization.
